(19) United States
(12) Patent Application Publication
(10) Pub. No.: US 2021/0331629 A1
(43) Pub. Date: Oct. 28, 2021

(54) VEHICLE PARTITION

(71) Applicant: Lyft, Inc., San Francisco, CA (US)

(72) Inventors: Marco Antonio Marroquin, San Francisco, CA (US); Alfred Charles Jones, II, San Francisco, CA (US); Jonathan Mazur Dyer, San Francisco, CA (US); John Michael Maddox, San Francisco, CA (US); David Timothy Milton, San Francisco, CA (US); Ibrahim Khaled Toukan, San Francisco, CA (US)

(21) Appl. No.: 17/236,686

(22) Filed: Apr. 21, 2021

Related U.S. Application Data
(60) Provisional application No. 63/014,122, filed on Apr. 22, 2020.
(60) Provisional application No. 63/040,441, filed on Jun. 17, 2020.

(51) Int. Cl. B60R 13/08

(52) U.S. Cl. CPC B60R 13/0823; B60R 2013/0807

(57) ABSTRACT

A vehicle partition configured to separate a first region and a second region of a vehicle cabin is provided. The vehicle partition may include a first panel member having a first attachment member configured to attach to a first seat of the vehicle cabin, a second panel member having a second attachment member configured to attach to a second seat of the vehicle cabin, and a third panel member connecting the first panel member to the second panel member. The first panel member may include a first panel and a first angled edge that is angled away from the first panel. The second panel member may include a second panel and a second angled edge that is angled away from the second panel.

### CROSS-REFERENCE TO RELATED APPLICATIONS

This application claims priority to and the benefit of U.S. Provisional Patent Application No. 63/014,122 filed Apr. 22, 2020 and entitled “VEHICLE PARTITION” which is hereby incorporated by reference in its entirety.

This application claims priority to and the benefit of U.S. Provisional Patent Application No. 63/040,441 filed Jun. 17, 2020 and entitled “VEHICLE PARTITION” which is hereby incorporated by reference in its entirety.

### TECHNICAL FIELD

One or more embodiments of the present disclosure relate generally to vehicle partitions and more particularly, for example, to a vehicle partition providing physical and particle barriers between first and second regions of a vehicle cabin.

### BACKGROUND

A ridesharing experience places a driver and a passenger in the same cabin of a vehicle. For various reasons, it may be desirable to separate a first region and a second region of the vehicle. However, solutions aimed at separating the first and second regions of the vehicle may be neither easy to install nor suitable for installation across a wide variety of vehicles.

### SUMMARY

Systems and methods are disclosed for a vehicle partition separating first and second regions of a vehicle cabin. In accordance with one or more embodiments, a vehicle partition configured to separate a front region and a rear region of a vehicle cabin is provided. The vehicle partition may include a first panel member having a first attachment member configured to attach to a first front seat of the front region of the vehicle cabin, a second panel member having a second attachment member configured to attach to a second front seat of the front region of the vehicle cabin, and a third panel member connecting the first panel member to the second panel member. The first panel member may include a first panel and a first angled edge that is angled away from the first panel. The second panel member may include a second panel and a second angled edge that is angled away from the second panel.

In accordance with one or more embodiments, a vehicle partition configured to provide a barrier between a first region and a second region of a vehicle cabin is provided. The vehicle partition may include a first panel member, a second panel member, and a third panel member connecting the first panel member to the second panel member. The first panel member may include (i) a first attachment member configured to attach the first panel member to a first seat of the first region of the vehicle cabin, and (ii) a first set of attachment apertures that are separated from each other by a distance and arranged along the first panel member. The second panel member may include (i) a second attachment member configured to attach the second panel member to a second seat of the first region of the vehicle cabin, and (ii) a second set of attachment apertures that are separated from each other by the distance separating each of the first set of attachment apertures from each other and arranged along the second panel member. The third panel member may include a plurality of interface members configured to concurrently interface with at least one of the apertures of the first set of attachment apertures and at least one of the apertures of the second set of attachment apertures so as to adjustably define a width of the vehicle partition.

In accordance with one or more embodiments, a vehicle partition positionable between first and second regions of a vehicle cabin is provided. The vehicle partition may include a first panel member having a first attachment member configured to attach to a first front seat of the front region of the vehicle cabin, a second panel member having a second attachment member configured to attach to a second front seat of the front region of the vehicle cabin, and a third panel member connecting the first panel member to the second panel member. The first panel member may include (i) a first panel and a first angled edge that is angled away from the first panel, and (ii) a first set of attachment apertures arranged along a first width of the first panel member. The second panel member may include (i) a second panel and a second angled edge that is angled away from the second panel, and (ii) a second set of attachment apertures arranged along a second width of the second panel member. The third panel member may include a plurality of interface members configured to concurrently interface with at least one of the apertures of the first set of attachment apertures of the first panel member and with at least one of the apertures of the second set of attachment apertures so as to adjustably define a width of the vehicle partition.

In accordance with one or more embodiments, a vehicle partition configured to separate a front region and a rear region of a vehicle cabin is provided. The vehicle partition may include a first member configured to attach to a first front seat of the front region of the vehicle cabin, a second member configured to attach to a second front seat of the front region of the vehicle cabin, and an interlock member connecting the first member to the second member. At least one of the first member, the second member, or the interlock member may include a light-transmissive material so that the vehicle partition is configured to separate the front region from the rear region of the vehicle cabin while enabling visible light to pass between the front and rear regions.

The vehicle partition may include a flexible lower portion coupled to at least one of the first member, the second member, or the interlock member. The flexible lower portion may be configured to enable the flexible lower portion to drape from the at least one of the first member, the second member, or the interlock member to a floor of the vehicle cabin. The vehicle partition may include a pliant interface member attachable to at least one of the first member, the second member, or the interlock member to fit the vehicle partition to the vehicle cabin. The pliant interface member may be a foam member or an inflated member configured to fill one or more gaps between the at least one of the first member, the second member, or the interlock member and the vehicle cabin. The interlock member may include a pair of channels receiving end portions of the first member and the second member. The interlock member may define a hinge structure that allows the first member to fold relative to the second member. The first member may extend vertically from a headliner of the vehicle cabin to below a first headrest of the first front seat. The second member may extend vertically from the headliner to below a second headrest of the second front seat. The first member may be secured to the first headrest via a first attachment strap. The second member may be secured to the second headrest via a second attachment strap.

In accordance with one or more embodiments, a vehicle partition configured to provide a physical and air barrier between a first region and a second region of a vehicle cabin is provided. The vehicle partition may include a rigid upper portion and a flexible lower portion coupled to the rigid upper portion. The flexible lower portion may be configured to drape from the rigid upper portion towards a floor of the vehicle cabin.

The rigid upper portion may include a first rigid member, a second rigid member, and an interlock member connecting the first rigid member to the second rigid member. At least one of the first rigid member, the second rigid member, or the interlock member may include light-transmissive material so that the vehicle partition is configured to separate the first region from the second region of the vehicle cabin while enabling visible light to pass between the first and second regions. The first rigid member and the second rigid member may be securable to respective front seats of the vehicle cabin. The first region may be a driver seat and the second region may be a passenger seat. Optionally, the first region is a front region of the vehicle cabin and the second region is a rear region of the vehicle cabin. The lower portion may be securable to at least one of the floor or the front seats of the vehicle cabin. The lower portion may include one or more pockets configured to store one or more items. The vehicle partition may include an interface member positionable between the vehicle cabin and at least one of the upper portion or the lower portion to fit the vehicle partition to the vehicle cabin.

In accordance with one or more embodiments, a vehicle partition positionable between first and second regions of a vehicle cabin defined by surfaces is provided. The vehicle partition may include a pre-tensioned frame and a transparent or semi-transparent window defined by the pre-tensioned frame. The pre-tensioned frame may be configured to press against at least one of the surfaces defining the vehicle cabin to secure the pre-tensioned frame against the at least one surface and separate the first and second regions.

The pre-tensioned frame may be foldable between a collapsed state and an expanded state. The at least one surface may be a headliner, a B-pillar, or a floor. The vehicle partition may include an interface member positionable between the vehicle cabin and the pre-tensioned frame. The vehicle partition may include at least one of a pocket, a communication device, an air filtration device, a spray system, a UVC emitter, or a display.

Additional features are set forth in part in the description that follows and will become apparent to those skilled in the art upon examination of the specification and drawings or may be learned by the practice of the disclosed subject matter. A further understanding of the nature and advantages of the present disclosure may be realized by reference to the remaining portions of the specification and the drawings, which forms a part of this disclosure.

One of skill in the art will understand that each of the various aspects and features of the disclosure may advantageously be used separately in some instances, or in combination with other aspects and features of the disclosure in other instances. Accordingly, individual aspects can be claimed separately or in combination with other aspects and features. Thus, the present disclosure is merely exemplary in nature and is in no way intended to limit the claimed invention or its applications or uses. It is to be understood that structural and/or logical changes may be made without departing from the spirit and scope of the present disclosure.

The present disclosure is set forth in various levels of detail and no limitation as to the scope of the claimed subject matter is intended by either the inclusion or non-inclusion of elements, components, or the like in this summary. In certain instances, details that are not necessary for an understanding of the disclosure or that render other details difficult to perceive may have been omitted. Moreover, for the purposes of clarity, detailed descriptions of certain features will not be discussed when they would be apparent to those with skill in the art so as not to obscure the description of the present disclosure. The claimed subject matter is not necessarily limited to the arrangements illustrated herein, with the scope of the present disclosure is defined only by the appended claims.

### BRIEF DESCRIPTION OF THE DRAWINGS

The description will be more fully understood with reference to the following figures in which components may not be drawn to scale, which are presented as various embodiments of the disclosure described herein and should not be construed as a complete depiction of the scope of the disclosure.

FIG. 1 illustrates a vehicle interior with a transition between a first region and a second region highlighted for reference in accordance with an embodiment of the disclosure.

FIG. 2 illustrates a first view of a vehicle partition positioned at the transition and showing an upper portion of the vehicle partition in accordance with an embodiment of the disclosure.

FIG. 3 illustrates a second view of the vehicle partition positioned at the transition and showing a lower portion of the vehicle partition coupled to the upper portion in accordance with an embodiment of the disclosure.

FIG. 4 illustrates a third view of the vehicle partition and showing one or more features associated with the lower portion of the vehicle partition in accordance with an embodiment of the disclosure.

FIG. 5 illustrates a fourth view of the vehicle partition and showing an interface member positioned between the upper portion and the vehicle interior in accordance with an embodiment of the disclosure.

FIG. 6 illustrates a first view of a second vehicle partition in accordance with an embodiment of the disclosure.

FIG. 7 illustrates a vehicle cabin in accordance with an embodiment of the disclosure.

FIG. 8 illustrates a first panel member or window of the second vehicle partition in accordance with an embodiment of the disclosure.

FIG. 9 illustrates an exploded view of an attachment connecting various components of the second vehicle partition together in accordance with an embodiment of the disclosure.

FIG. 10 illustrates a first view of the second vehicle partition positioned within the vehicle interior of FIG. 7 in accordance with an embodiment of the disclosure.

FIG. 11 illustrates a second view of the second vehicle partition positioned within the vehicle interior of FIG. 7 in accordance with an embodiment of the disclosure.

FIG. 12 illustrates a first view of a third vehicle partition positioned between a first region and a second region of a vehicle interior in accordance with an embodiment of the disclosure.

FIG. 13 illustrates a second view of the third vehicle partition and showing one or more pockets associated with the third vehicle partition in accordance with an embodiment of the disclosure.

FIG. 14 illustrates a third view of the third vehicle partition and showing a speaker and microphone setup for two-way communication between a driver and a passenger in accordance with an embodiment of the disclosure.

FIG. 15 illustrates a fourth view of the third vehicle partition and showing one or more features for one-way or two-way airflow across the third vehicle partition in accordance with an embodiment of the disclosure.

FIG. 16 illustrates a fifth view of the third vehicle partition and showing the third vehicle partition including a particle removal spray system in accordance with an embodiment of the disclosure.

FIG. 17 illustrates a sixth view of the third vehicle partition and showing the third vehicle partition including a UVC emitter integrated with the third vehicle partition in accordance with an embodiment of the disclosure.

FIG. 18 illustrates a seventh view of the third vehicle partition and showing the third vehicle partition including a display in accordance with an embodiment of the disclosure.

Embodiments of the disclosure and their advantages are best understood by referring to the detailed description that follows. It should be appreciated that like reference numerals are used to identify like elements illustrated in one or more of the figures.

### DETAILED DESCRIPTION

Solutions for separating regions of a vehicle can include barriers that are formed from a single sheet of rigid, semi-rigid or flexible material. However, using a single sheet of rigid or semi-rigid material may be difficult to install or remove from the vehicle and must be shaped for a particular vehicle (e.g., specific year, make, and model of the vehicle) to minimize fit issues including potential interference with deploying passive restraints such as airbags. Single piece rigid solutions are also large and difficult/costly to ship. A single, rigid sheet can also be heavy, thick, and unforgiving should contact between the sheet and person occur, such as in a crash. Also, the material of the rigid barrier can be scratched, affecting the optical clarity of the barrier. Replacement of the entire rigid barrier, such as when the material becomes excessively scratched, can be costly and time consuming.

Flexible solutions include a single sheet formed of deformable material (e.g., clear vinyl or other film-like material) that is secured to the vehicle interior to drape between the first and second regions of the vehicle Like the rigid solutions discussed above, flexible solutions can be difficult or costly to install. For example, flexible solutions may require expert installation to properly form or shape the flexible barrier to the specific vehicle. Flexible barrier solutions may also not provide a clear view through the flexible barrier material. For example, inadequate tension of the deformable material may leave wrinkles and other deformities within the material, thereby reducing the optical clarity of the barrier and producing an undesired appearance of the barrier. Flexible solutions may also be difficult to clean due to the flexible nature of the barrier material itself. Additionally, flexible solutions may not conform in fit to the dimensions of the vehicle cabin.

Therefore, there is a need in the art for a vehicle partition or barrier that addresses the deficiencies noted above, other deficiencies known in the industry, or at least offers an alternative to current techniques. For example, improvements are needed for an economic and protective barrier or partition that is also relatively easy to install.

According to the present disclosure, a vehicle partition providing physical and air barriers between first and second regions of a vehicle cabin is provided. The vehicle partition may include a modular design with interlocking partition members that may be separated or folded, such as to reduce a packaging size of the vehicle partition and/or allow for individual replacement of the various partition members. In some embodiments, the vehicle partition may be collapsible, expandable and lightweight, enabling the partition to be quickly and easily collapsed and folded into a compact shape, such as to be shipped in an economic manner. The vehicle partition may include a transparent or semi-transparent material or viewing window that enables a driver to see through the partition and into the second region and outside vehicular traffic and environment. Portions of the vehicle partition may eliminate or minimize passage of particles, air, or gas between the first and second regions. In some embodiments, an interface or sealing member may fill or conceal one or more gaps between the edges of the vehicle partition and surfaces of the vehicle cabin to at least partially restrict air and particles from circulating between the first and second regions of the vehicle cabin. The vehicle partition may include one or more features to provide a degree of adjustability for imparting a universal vehicle fit, such that the vehicle partition may fit multiple vehicles and vehicle types.

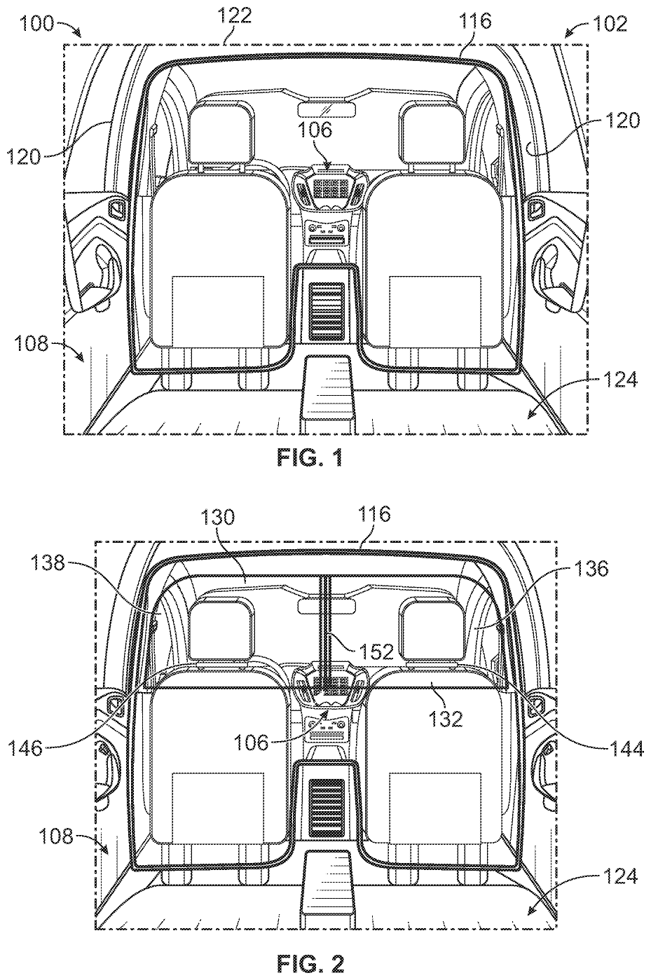

FIG. 1 illustrates a vehicle interior with a transition between a first region and a second region highlighted for reference in accordance with an embodiment of the disclosure. Referring to FIG. 1, a vehicle 100 (e.g., a car, truck, van, sport utility vehicle, etc.) includes a vehicle cabin 102 defining a vehicle interior with a first region 106 and a second region 108. The first and second regions 106, 108 may be any adjacent regions of the vehicle cabin 102. For example, the first region 106 may be a driver region of the vehicle cabin 102, and the second region 108 may be a passenger region of the vehicle cabin 102. In like manner, the first region 106 may be a front region of the vehicle cabin 102, and the second region 108 may be a rear region of the vehicle cabin 102. In some embodiments, the first region 106 may be an area of the vehicle cabin 102 defined at least by the front seats of the vehicle 100. The second region 108 may be an area of the vehicle cabin 102 defined at least by the rear seats of the vehicle 100.

Such configurations are exemplary only, and other configurations are contemplated. For example, the first region 106 may be defined by the driver seat only, with the second region 108 defined by all other passenger seats, including the front passenger seat. In some embodiments, the first region 106 may include the driver seat and the second region 108 may include the front passenger seat. In this manner, “front” and “rear” are terms of convenience only and do not limit any specific regions of the vehicle cabin 102. For example, the first region 106 may be any region of the vehicle cabin 102 designed for a driver of the vehicle 100, and the second region 108 may be any region of the vehicle cabin 102 designed for a passenger of the vehicle 100, whether in the front or rear of the vehicle cabin 102. In some embodiments, the first region 106 may be any region of the vehicle cabin 102 designed for a first passenger of the vehicle 100, and the second region 108 may be any region of the vehicle cabin 102 designed for a second passenger of the vehicle 100, such as left and right regions of the rear seats of the vehicle 100, among others. In some embodiments, the first region 106 and/or the second region 108 may be separated by a vehicle partition, and additional regions, such as third and fourth regions, may be separated by one or more additional vehicle partitions, the vehicle partition(s) will be described in greater detail herein.

A transition 116 between the first region 106 and the second region 108 is highlighted in FIG. 1 for illustration purposes. As shown, the transition 116 may extend along or adjacent to the B-pillars 120 of the vehicle cabin 102 and along the headliner 122 and floor 124 of the vehicle cabin 102 between the B-pillars 120, although other configurations are contemplated, such as anywhere rearwardly from the front seats, or the like.

Because the vehicle cabin 102 is open between the first and second regions 106, 108, particles and agents may pass through the air between the first region 106 and the second region 108 in the absence of a barrier or partition separating the first and second regions 106, 108. For instance, particles and agents may travel between the first region 106 and the second region 108, such as from the first region 106 to the second region 108 or from the second region 108 to the first region 106. In some examples, it should be noted that particles and agents may be minimized from passing through the air between the first and second regions 106, 108 if the vehicle cabin 102 is exposed to outside air (e.g., window is open, etc.). However, exposing the vehicle cabin 102 to outside air may not be feasible or practical in certain situations.

FIG. 2 illustrates a first view of a vehicle partition 130 in accordance with an embodiment of the disclosure. As described herein, the vehicle partition 130 may be positioned (e.g., at the transition 116) to eliminate or minimize potential transmission of particles and agents through the air between the first region 106 and the second region 108. In some examples, certain types of particles and agents may not be transmitted through the air in the vehicle cabin 102. As shown, the vehicle partition 130 may include an upper portion 132 configured to span a width of the vehicle cabin 102 at or near the transition 116. For example, the upper portion 132 may be configured to fit an upper area of the vehicle cabin 102 at the transition 116, such as the area behind and above the headrests of the front seats. Depending on the application, the upper portion 132 may span the entire width of the vehicle cabin 102 at or near the transition 116 or span a width less than the entire width of the vehicle cabin 102 at or near the transition 116, such that one or more gaps are created between the upper portion 132 and the vehicle interior. The upper portion 132 may fit generally, perfectly, or imperfectly to the dimensions of the vehicle interior at or near the transition 116.

The upper portion 132 may include a plurality of members. For example, the upper portion 132 may include a first member 136 or window, a second member 138 or window, and an interlock member 152, or any combination thereof. Depending on the application, the first member 136 may be a passenger member positioned at least partially behind the front passenger seat. For example, the first member 136 may extend vertically from the headliner 122 to below the headrest of the front passenger seat. In some embodiments, the first member 136 may extend vertically from the headliner 122 to the floor 124 of the vehicle cabin 102 behind the front passenger seat. Similarly, the second member 138 may be a driver member positioned at least partially behind the driver seat. Like the first member 136, the second member 138 may extend vertically from the headliner 122 to below the headrest of the driver seat. In some embodiments, the second member 138 may extend vertically from the headliner 122 to the floor 124 of the vehicle cabin 102 behind the driver seat.

Depending on the application, the first member 136 and the second member 138 may be mirror images of each other. For example, each of the first member 136 and the second member 138 may extend up to or near a vertical centerline of the vehicle cabin 102, with the peripheries of the first member 136 and the second member 138 being mirror images of each other across the vertical centerline. In such embodiments, the first member 136 may be utilized as the second member 138, or vice versa, when the orientations of the first member 136 and the second member 138 are reversed. Such configurations may limit manufacturing costs and facilitate modularity of the vehicle partition 130 and/or part replacement, as explained below. In some examples, portions of the first member 136 and/or the second member 138 may extend towards the armrest that separates the driver and front passenger seats. In some examples, the first and second members 136, 138 may be a variety of shapes including generally polygonal, L-shape, T-shape, irregular, circular, and the like.

The upper portion 132 may permit viewing through the vehicle partition 130. For instance, at least one of (e.g., each of) the first member 136, the second member 138, or the interlock member 152 may be transparent or semi-transparent to allow viewing through the upper portion 132. The transparency or semi-transparency of the first member 136, the second member 138, or the interlock member 152 may enable the driver to see through the upper portion 132 and into the second region 108 and/or outside vehicular traffic and environment. For instance, at least one of the first member 136, the second member 138, or the interlock member 152 may include light-transmissive material that enables visible light to pass (e.g., unimpeded) between the first and second regions 106, 108 through the upper portion 132.

Each of the first member 136, the second member 138, and the interlock member 152 may be formed from rigid or semi-rigid material. Examples include polycarbonate or acrylic material. Such materials are exemplary only, and each of the first member 136, the second member 138, and the interlock member 152 may be formed from other materials. The upper portion 132 may be configured to minimize or prevent transmission of particles, air, gas and/or agents between the first region 106 and the second region 108. For example, the material of the upper portion 132 may prevent or minimize transmission of particles, gas, air, and/or agents through the material. In some examples, the interlock member 152 may be formed of flexible, rigid, or semi-rigid material so that the first and second members 136, 138 are coupled to the interlock member 152 to form a T-shape design.

The upper portion 132 may be secured in place in many configurations. In one embodiment, the first member 136 and the second member 138 may be secured to respective front seats of the vehicle cabin 102. For example, the first member 136 may be secured to the headrest of the front passenger seat via a first attachment strap 144 wrapped around the headrest or adjustment posts of the headrest. The first attachment strap 144 may be secured to the headrest of the front passenger seat via buttons, buckles, clips, hook and loop tape, adhesive, or the like. In like manner, the second member 138 may be secured to the headrest of the driver seat via a second attachment strap 146 wrapped around the headrest or adjustment posts of the headrest. The second attachment strap 146 may be secured to the headrest of the driver seat via buttons, buckles, clips, hook and loop tape, adhesive, or the like.

In some embodiments, the upper portion 132 may be formed from interlocking frame members. For instance, the first member 136 may be connected to the second member 138 by the interlock member 152. The interlock member 152 may be specific to one or more vehicles, with the first member 136 and the second member 138 being universal or generally universal to multiple vehicles. For example, a wider or narrower interlock member 152 may be used for wider or narrower vehicle cabins, respectively, with the first member 136 and the second member 138 being the same or having the same dimensions for the different vehicle widths. The interlock member 152 may be a trim piece interlocking the first and second members 136, 138 together. In one embodiment, the interlock member 152 may be an H-trim or H-molding having a pair of channels in which to receive end portions of the first member 136 and the second member 138. In some embodiments, the interlock member 152 may be a frame member securing the first member 136 relative to the second member 138. For instance, the interlock member 152 may define at least a portion of a frame positioning the first member 136 relative to the second member 138.

In some embodiments, the interlock member 152 may be a hinge-type member allowing pivoting movement between the first member 136 and the second member 138. In such embodiments, the first member 136 may fold relative to the second member 138 (e.g., similar to a book) to collapse the upper portion 132. In some embodiments, the interlock member 152 may define a slide lock mechanism allowing the first and second members 136, 138 to slide into place relative to each other and then lock once the first member 136 and the second member 138 are folded outwardly away from each other into a single plane. Such configurations are exemplary only, and the interlock member 152 may include other configurations interlocking the first member 136 to the second member 138. The first member 136, second member 138, and interlock member 152 may include a tool-less design to interlock the members together, such as in the manners discussed above. The tool-less design may facilitate an ease of installation of the vehicle partition 130, such that the vehicle partition 130 may be self-installed by many drivers without the need for expert installation.

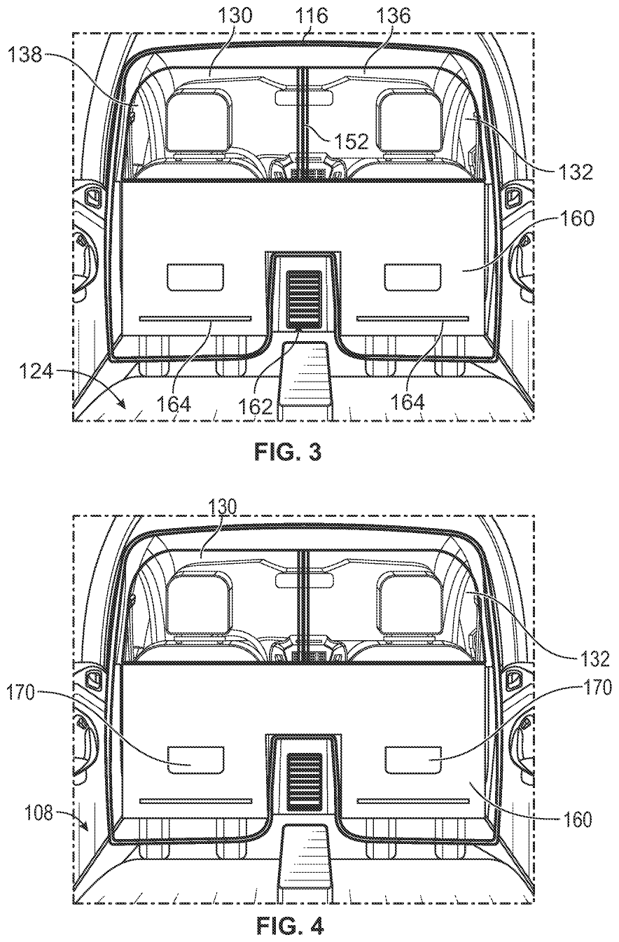

FIG. 3 illustrates a second view of the vehicle partition 130 in accordance with an embodiment of the disclosure. As shown, the vehicle partition 130 may include a lower portion 160 coupled to the upper portion 132 (e.g., to at least one of the first member 136, the second member 138, or the interlock member 152). The lower portion 160 may extend between the B-pillars 120 of the vehicle cabin 102. For example, the lower portion 160 may be connected to the B-pillars 120 to extend the entire width of the vehicle cabin 102. In some embodiments, the lower portion 160 may include a width less than the width of the vehicle cabin 102 (e.g., extending only between the front seats, extending to cover the space between the front seats, etc.). The lower portion 160 may be formed from flexible material configured to drape from the upper portion 132 to or near the vehicle's floor 124 at or near the transition 116. For example, the lower portion 160 may be formed from vinyl or nylon shaped to fit or generally fit a lower area of the vehicle cabin 102 at the transition 116, such as the area behind the front seats and below the headrests of the front seats. Such materials are exemplary only, and the lower portion 160 may be formed from other materials. The lower portion 160 may be configured to minimize or prevent transmission of particles, air, gas, and/or agents between the first region 106 and the second region 108. For example, the material of the lower portion 160 may prevent or minimize transmission of particles, air, gas, and/or agents through the material.

The lower portion 160 may include one or more features to fit the lower portion 160 to the lower area of the vehicle cabin 102. For example, the lower portion 160 may include one or more cutouts 162 to account for one or more vents of the vehicle's HVAC system. In some embodiments, the lower portion 160 may include one or more securement straps 164 configured to secure the lower portion 160 to the B-pillars 120, the bottom of the front seats, and/or to the floor 124 at or near the transition 116, or any combination thereof. The securement straps 164 may be double-sided adhesive tape, hook and loop tape, or the like. In some embodiments, the lower portion 160 may include a weighted bottom seam to tension the lower portion 160 in the vehicle 100.

Referring to FIGS. 2-3, the vehicle partition 130 may be modular in design. For example, each of the first member 136, the second member 138, the interlock member 152, and the lower portion 160 may be separated for assembly/disassembly and/or shipping purposes. Specifically, if only a portion of the vehicle partition 130 needs to be replaced (e.g., only one of the first and second members 136, 138, only the interlock member 152, only the lower portion 160, only the first member 136 and the lower portion 160, etc.), one or more replacement parts can be obtained without replacing the entire vehicle partition 130. For example, if first member 136 becomes excessively scratched, a replacement order for only a new first member 136 can be placed.

The modularity of the design may also facilitate easier and less costly shipping of the vehicle partition 130. For example, the vehicle partition 130 may be collapsed or disassembled (e.g., each of the first member 136 and the second member 138 removed from the interlock member 152, the first and second members 136, 138 folded together, the lower portion 160 folded, etc.) such that the entirety of the vehicle partition 130 can fit inside a shipping box (e.g., a 2′×2′×3″ shipping box). As such, the vehicle partition 130 can be packaged, stored, or shipped in an economic manner.

FIG. 4 illustrates a third view of the vehicle partition 130 and showing one or more features associated with the lower portion 160 of the vehicle partition 130 in accordance with an embodiment of the disclosure. As shown, the lower portion 160 may include one or more pockets 170 in which to store items. For example, the one or more pockets 170 may be configured to store cleaning supplies (e.g., hand sanitizer, etc.), hygiene products (e.g., tissue), or other items. Depending on the application, the one or more pockets 170 may be formed integrally with the lower portion 160 or the one or more pockets 170 may be separate pieces attachable to the lower portion 160 if desired. This enables storage of items even though the back of the driver and passenger seats, where storage pockets are typically located, are covered or otherwise rendered inaccessible by the lower portion 160.

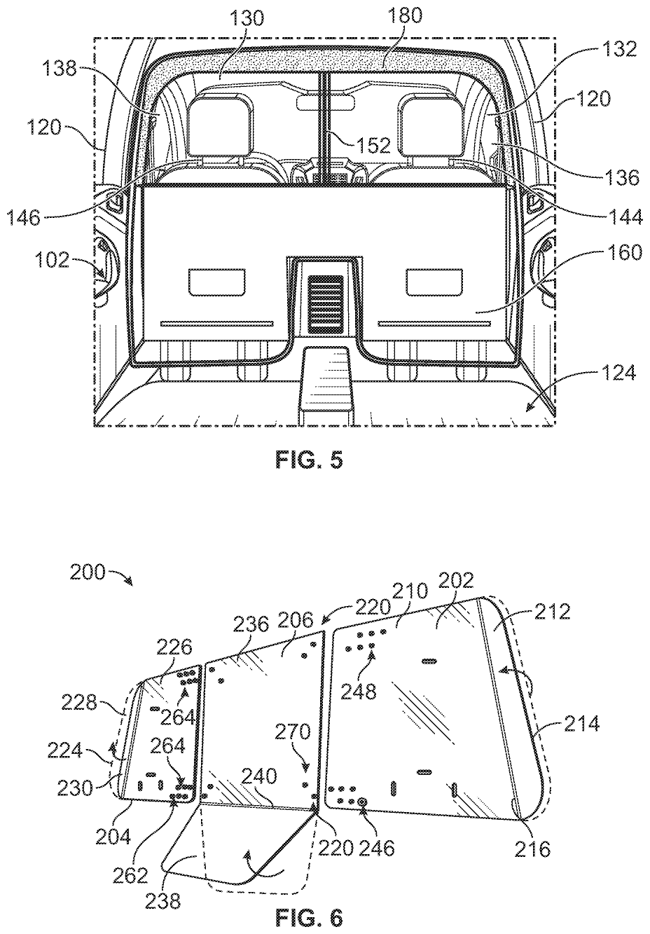

FIG. 5 illustrates a fourth view of the vehicle partition 130 in accordance with an embodiment of the disclosure. Referring to FIG. 5, the vehicle partition 130 may include one or more features allowing the vehicle partition 130 to be fitted to in many vehicles of different shapes and sizes. For example, the first member 136 of the upper portion 132 may be shaped to generally fit a first side (e.g., a passenger side, a right side, etc.) of the vehicle cabin 102, and the second member 138 may be shaped to generally fit a second side (e.g., a driver side, a left side, etc.) of the vehicle cabin 102, such as an upper periphery of each of the first member 136 and the second member 138 being arcuately shaped to generally fit the headliner and B-pillar areas of a wide variety of vehicles.

In some embodiments, the interlock member 152 may adjustably position the first member 136 relative to the second member 138, such as in a sliding relationship. In such embodiments, the first member 136 may be slid relative to the second member 138, or vice versa, to adjustably fit the upper portion 132 to the vehicle cabin 102. In some embodiments, the interlock member 152 may be omitted from the vehicle partition 130, with the first and second members 136, 138 positioned in an overlapping relationship, such as in an overlapping sliding relationship. In such embodiments, the overlapping first and second members 136, 138 may be slid relative to each other to adjustably fit the upper portion 132 of the vehicle partition 130 to the vehicle cabin 102. For example, the first and second members 136, 138 may be slid towards each other to generally fit a narrower vehicle cabin 102. In like manner, the first and second members 136, 138 may be slid away from each other to generally fit a wider vehicle cabin 102.

In some embodiments, each of the first attachment strap 144 and the second attachment strap 146 may be adjustable to adjust the position of the vehicle partition 130 (e.g., the upper portion 132) within the vehicle cabin 102. For instance, the length of the first attachment strap 144 may be adjusted (e.g., similar to a backpack fit) to adjust the position of the first member 136 relative to the headrest of the front passenger seat to provide a further degree of adjustability for imparting a universal vehicle fit. Specifically, the amount of slack in the first attachment strap 144 may be increased to position the first member 136 lower relative to the headrest, or vice versa. In like manner, the length of the second attachment strap 146 may be adjusted (e.g., similar to a backpack fit) to adjust the position of the second member 138 relative to the headrest of the driver seat to provide a further degree of adjustability for imparting a universal vehicle fit.

In some embodiments, the vehicle partition 130 may include an interface member 180 positioned between at least portions of the vehicle partition 130 and the vehicle interior to fit the vehicle partition 130 to the vehicle cabin 102. As shown in FIG. 5, the interface member 180 may be positioned between the upper portion 132 and the vehicle interior, although other configurations are contemplated, including embodiments in which the interface member 180 extends along the lower portion 160, along the entire periphery of the vehicle partition 130, or the like. As described herein, the interface member 180 may fill or substantially fill one or more gaps between the vehicle partition 130 and the vehicle cabin 102 to further minimize or prevent transmission of particles and agents between the first region 106 and the second region 108. For example, because the upper portion 132 is sized and shaped to fit a wide variety of vehicles, unique small or substantial gaps may exist between the upper portion 132 and the headliner 122 and the B-pillars 120 of the vehicle cabin 102 from vehicle to vehicle. In such embodiments, the interface member 180 may fill the gaps, effectively trimming out the vehicle partition 130 to the vehicle cabin 102.

The interface member 180 may include many configurations. For example, and without limitation, the interface member 180 may be pliant and embodied as a foam member that deforms to generally fit the vehicle cabin 102. In some embodiments, the interface member 180 may be pliant and embodied as a pneumatic member that is inflated to generally fit the vehicle cabin 102. In some embodiments, the interface member 180 may be a piece of fabric material configured to drape across the gap(s) between the vehicle partition 130 and the vehicle interior. In some embodiments, the interface member 180 may be configured to seal at least the upper portion 132 of the vehicle partition 130 to the vehicle cabin 102 to further minimize or prevent transmission of particles, air, gas, and/or agents in the space between the first region 106 and the second region 108. Depending on the application, the interface member 180 may be coupled to the vehicle interior and/or to the vehicle partition 130, such as through double-sided adhesive tape, hook and loop tape, or other fastening mechanisms.

FIG. 6 illustrates a first view of a second vehicle partition 200 for positioning within the vehicle cabin 102 in accordance with an embodiment of the disclosure. Except as otherwise noted below, the second vehicle partition 200 may be similar to the vehicle partition 130 of FIGS. 2-5, described above, or vice versa. Accordingly, descriptions of like features may be omitted for the sake of convenience and clarity. In addition, one or more features described below with reference to the second vehicle partition 200 may be implemented on the vehicle partition 130 of FIGS. 2-5. In like manner, any feature of vehicle partition 130 described above may be implemented on the second vehicle partition 200, unless otherwise noted.

The second vehicle partition 200 may include many configurations operable to separate the first region 106 and the second region 108 of the vehicle cabin 102, such as to minimize potential transmission of particles, air, gas, and/or agents between the first region 106 and the second region 108. For example, the second vehicle partition 200 may include a plurality of members positionable at or near the transition 116 between the first region 106 and the second region 108, such as along or adjacent to the B-pillars 120 of the vehicle cabin 102 and along or adjacent to the headliner 122 between the B-pillars 120. Like the vehicle partition 130, the second vehicle partition 200 may be configured to fit multiple vehicles and vehicle types.

Referring to FIG. 6, the second vehicle partition 200 may include a first panel member 202, a second panel member 204, and a third panel member 206. The first panel member 202 may be similar to the first member 136, described above, and the second panel member 204 may be similar to the second member 138, described above. For example, the first panel member 202 may be a transparent window or panel positionable at least partially behind the front passenger seat, and the second panel member 204 may be a transparent window or panel positionable at least partially behind the driver seat. In some embodiments, the third panel member 206 may be similar to the interlock member 152, described above. For instance, the third panel member 206 may be a transparent window or panel configured to connect the first panel member 202 and the second panel member 204 together, as explained below.

The first panel member 202 may include many configurations. As one example, the first panel member 202 may include a first panel 210 and a first angled edge 212 or panel that is angled away from the first panel 210. Depending on the application, the first panel 210 and first angled edge 212 may be formed from a single sheet of material, such as from a single sheet of polycarbonate material, or may be separate elements connected together. The first panel 210 may be generally flat with one or more features defined in or on the first panel 210 to attach the first panel member 202 to the third panel member 206, as explained below. In some examples, the first panel 210 may have a generally polygonal shape, as shown in FIG. 6, the first panel 210 may have a right trapezoid shape or similar to generally fit the first panel member 202 to the space behind the front passenger seat at the transition 116 between the front region and the rear region of the vehicle cabin 102. The first angled edge 212 may include arcuate or angled edges. For example, the first angled edge 212 may generally curve along its edge from the top of the first panel member 202 to the bottom of the first panel member 202, although other configurations are contemplated. In some examples, the first angled edge 212 may transition gradually or abruptly along a first bend 216 of the first panel 210. In some embodiments, the first angled edge 212 has a width and/or surface area that is less than a width and/or surface area of the first panel 210. Although FIG. 6 shows a leading edge 214 of the first angled edge 212 having a curved or beveled shape, it should be noted that the shape of the leading edge 214 may also be curvilinear, angular, or chamfered.

The first angled edge 212 may extend at an angle relative to the first panel 210. In some embodiments, the first panel member 202 may include a first bend 216 at the transition between the first panel 210 and the first angled edge 212 to extend the first angled edge 212 at an angle from the first panel 210. In some embodiments, the angle may be defined by the attachment of the first angled edge 212 to the first panel 210 or the angle may be defined by a hinge structure between the first angled edge 212 and the first panel 210. For example, the first angled edge 212 and the first panel 210 may be integrally formed or adhered together. In one embodiment, the transition between the first panel 210 and the first angled edge 212 may include or define a living hinge structure allowing the first angled edge 212 to bend relative to the first panel 210 along the living hinge at the transition. In this manner, “bend” may be broad to encompass curves in material, hinges, and other structures configured to create an angle between the first panel 210 and the first angled edge 212. Depending on the application, the angle between the first panel 210 and the first angled edge 212 may be fixed, such as formed during formation of the first panel member 202, or may be adjustable. For instance, the first angled edge 212 may be bent along or adjacent to the transition between the first panel 210 and the first angled edge 212 to adjust the first bend 216 and fit the first panel member 202 to the vehicle cabin 102. In this manner, the first panel member 202 may be provided, at least initially, in a flat shape (e.g., for shipping purposes), and a user or installer may bend the first angled edge 212 as desired or needed to fit the first panel member 202 to the vehicle cabin 102.

The angle along the first bend 216 between the first angled edge 212 and the first panel 210 may be any suitable angle. For example, the suitable angle may be less than 90° so that the first angled edge 212 does not angle inwards towards a person sitting in the front passenger seat. For example, the suitable angle may be at least 1° or greater to less than 180°. For example, the angle may be set to wrap the first panel member 202 at least partially around the headrest of the front passenger seat. In some embodiments, the angle may be set to fit or generally fit the first angled edge 212 between the headrest of the front passenger seat and the adjacent B-pillar 120. In some embodiments, the angle may be set such that the first panel member 202 does not interfere or minimally interferes with the functionality of the airbag system (e.g., the side airbag). For example, the angle between the first panel 210 and the first angled edge 212 may facilitate effective deployment of the airbag system along the B-pillar 120, such as providing sufficient clearance for proper deployment of the airbag system. In particular, when the airbag is deployed along the B-pillar 120 adjacent to the first panel member 202, the airbag may expand towards the first panel member 202. By angling the first angled edge 212 away from the first panel 210, the width of the first panel 210 is maximized so as to maximize the amount of physical barrier of between the first region 106 and the second region 108 while concurrently imparting an amount of distance between the adjacent B-pillar 120 relative to the first panel 210 and the first angled edge 212 that enables the airbag to fully deploy without impacting the first panel member 202. In some instances, if the airbag does come into contact with a portion of the first panel member 202, the first bend 216 may be configured to deflect a portion of the force associated with the deployment of the airbag away from the first panel member 202 so as to minimize the amount of force that is exerted against the first panel member 202. In some embodiments, as shown in FIG. 6, the leading edge 214 of the first angled edge 212 may be preferentially angled towards the front of the vehicle (e.g., the side mirror) instead of angled towards the rear of the vehicle (e.g., the rear passenger window) due to the manner in which a side airbag is configured to deploy. For example, the portion of the airbag along the B-pillar 120 may be more bulbous or larger when deployed relative to other portions of the airbag (e.g., along the windows). By angling the leading edge 214 of the first angled edge 212 towards the front of the vehicle may avoid causing the first angled edge 212 from potentially contacting and puncturing the airbag as the airbag is being deployed. In other words, angling the leading edge 214 of the angled edge 212 towards the front of the vehicle may impart sufficient clearance distance for the more bulbous portion of the deployed airbag corresponding to the B-pillar 120 compared to angling the leading edge 214 towards the rear of the vehicle. Additionally, angling the leading edge 214 of the angled edge 212 towards the front of the vehicle may impart greater rigidity of the first panel member 202 and/or tolerance if the first panel member is contacted by a portion of the airbag compared to angling the leading edge 214 towards the rear of the vehicle. In other embodiments, the leading edge 214 of the angled edge 212 may be angled towards the rear of the vehicle. In some embodiments, the first bend 216 between the first panel 210 and the first angled edge 212 may allow the first angled edge 212 to flex during deployment of the airbag system. Flexing of the first angled edge 212 relative to the first panel 210 may limit failure of the second vehicle partition 200 caused by contact with the first angled edge 212, such as from contact of the airbag system with the first angled edge 212 during a crash.

The second panel member 204 may include a configuration similar to the first panel member 202. For example, the second panel member 204 may include a second panel 226, a second angled edge 228 or panel extending from the second panel 226, a second bend 230 at the transition between the second panel 226 and the second angled edge 228, and a second leading edge 224 along the second angled edge 228. The second leading edge 224, the second panel 226, second angled edge 228, and second bend 230 may be similar to the first leading edge 214, the first panel 210, first angled edge 212, and first bend 216, respectively of the first panel member 202, described above. Thus, any description above of the first panel member 202 may apply to the second panel member 204.

The third panel member 206 may include many configurations to secure the first panel member 202 to the second panel member 204. The third panel member 206 may include a third panel 236, a third angled edge 238 or panel extending from the third panel 236, and a third bend 240 at the transition between the third panel 236 and the third angled edge 238. In some examples, the third panel 236 has a width and/or size and shape that is sufficient to connect the first panel member 202 to the second panel member 204.

As shown in FIG. 6, the third panel 236 may have a shape (e.g., a rectangle shape). The shape may be complementary to the shape of the first panel member 202 and the second panel member 204. For example, the lengths of the first panel member 202, the second panel member 204, and the third panel 236 of the third panel member 206 may be similar or identical. In such embodiments, the top edges of the first panel member 202 and the second panel member 204 may align with the top edge of the third panel 236 of the third panel member 206. In like manner, the bottom edges of the first panel member 202 and the second panel member 204 may align with the bottom of the third panel 236 of the third panel member 206, such as aligning with the third bend 240 of the third panel member 206. In some examples, the lengths of the first panel member 202, the second panel member 204, and the third panel 236 of the third panel member 206 may be similar or identical so that the vehicle partition may be packaged, shipped, and/or stored in an economic manner. Additionally, the lengths of the first panel member 202, the second panel member 204, and the third panel 236 of the third panel member 206 may be similar or identical so that the overall (i.e., aggregated) width of the second vehicle partition 200 is constant and conforms to the roof liner of the vehicle.

Like the first panel member 202 and the second panel member 204, the third panel 236 and the third angled edge 238 of the third panel member 206 may be formed from a single sheet of material, such as from a single sheet of polycarbonate or acrylic material, or may be separate elements connected together. The third panel 236 may be generally flat with one or more features defined in or on the third panel 236 to attach the third panel member 206 to the first panel member 202 and the second panel member 204, as explained below. For instance, the third panel member 206 may include a plurality of interface members 220 configured to interface with one or more apertures of the first panel member 202 and the second panel member 204 for receipt of one or more mechanical fasteners therethrough, as explained below.

As shown, the third angled edge 238 may be defined on a lower edge of the third panel 236. Like the first panel member 202 and the second panel member 204, the third angled edge 238 may extend at an angle to the third panel 236, as defined by the third bend 240 between the third panel 236 and the third angled edge 238. The angle between the third panel 236 and the third angled edge 238 may be any suitable angle. For example, the angle between the third panel 236 and the third angled edge 238 may be set to fit or generally fit the third panel member 206 to the shape of the front seats. Specifically, the angle may be set such that the third angled edge 238 follows or generally follows a contour of the front seats, such as a rear contour of the front seats to a center console of the vehicle. The third angled edge 238 may extend from the third panel 236 so that when the third panel member 206 is installed within the vehicle, the third angled edge 238 extends towards a center armrest of the vehicle so as to increase the physical barrier between the first region 106 and the second region 108. Additionally, the third angled edge 238 may have a size and shape that minimizes and/or eliminates any gap between the front driver seat and front passenger seat. In some examples, the third bend 240 is set at a fixed angle or an adjustable angle. In particular, a hinge may be set along the third bend 240 so as to enable the third angled edge 238 to flex relative to the third panel 236. Thereafter, the hinge may include a locking mechanism so as to fix the adjusted angle between the third angled edge 238 and the third panel 236. Beneficially, the angle between the third angled edge 238 and the third panel 236 may be set so as to provide a physical and air barrier along the armrest. As will be described in greater detail herein, the distances of the first panel member 202 may be adjusted relative to the second panel members 204 by using the third panel member 206 so as to substantially fill in any gap between the front driver seat and the front passenger seat.

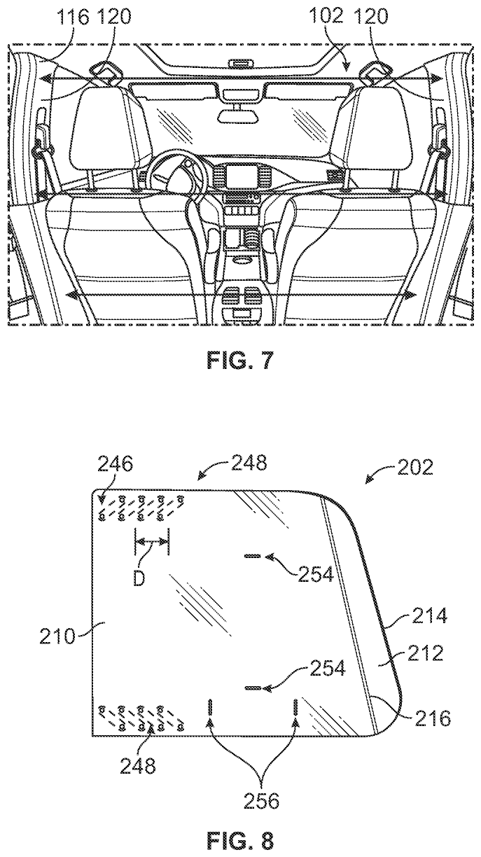

FIG. 7 illustrates the vehicle cabin 102 in accordance with an embodiment of the disclosure. As described herein, the second vehicle partition 200 may be adjustable to fit the second vehicle partition 200 to the vehicle interior. As one embodiment, the second vehicle partition 200 may be adjustable or reconfigurable to span a width of the vehicle cabin 102 at or near the transition 116. Depending on the application, the second vehicle partition 200 may be assembled based on the width of the vehicle cabin 102 between the B-pillars 120 and at a position level with the base of the headrests of the front seats. In some embodiments, the width measurement may be a maximum width measurement of the vehicle cabin 102. Should a width measurement be taken above the headrests or near the floor of the vehicle cabin 102, the sizing of the second vehicle partition 200 may be incorrect. For example, taking a width measurement above the headrests may result in the second vehicle partition 200 being assembled too small for the vehicle cabin 102. In some embodiments, the width of the second vehicle partition 200 is adjustable so that the second vehicle partition 200 provides a physical and/or air barrier between the first region 106 and the second region 108 while concurrently enabling side airbags of the vehicle to be effectively deployed.

FIG. 8 illustrates the first panel member 202 in accordance with an embodiment of the disclosure. As shown, the first panel member 202 may include one or more attachment features to connect the first panel member 202 to the third panel member 206 and/or to a headrest of the vehicle. For example, the first panel member 202 may include a first set of attachment apertures 246. As shown, the first set of attachment apertures 246 may be disposed along a portion of a width of the first panel 210, such as along or adjacent to the top and bottom edges of the first panel 210. In some embodiments, each consecutive aperture of the first set of attachment apertures 246 may be spaced apart by different distances. In some embodiments, each of the attachment apertures of the first set of attachment apertures 246 may be separated by a distance D. For example, each aperture of the first set of attachment apertures 246 may be spaced incrementally along the first panel member 202 by distance D.

By separating each of the attachment apertures by the same distance D, the first set of attachment apertures 246 may impart incremental fixed changes to the width of the second vehicle partition 200. For instance, selective engagement or interfacing of the third panel member 206 with at least one attachment aperture of the first set of attachment apertures 246 along the width of the first panel member 202 may adjust a width of the second vehicle partition 200 to one of a first plurality of width positions each separated by the distance D. In some embodiments, the first set of attachment apertures 246 may include one or more first pairs of attachment apertures 248 arranged along the first panel member 202 and each separated by the distance D. For example, one or more pairs of attachment apertures 248 may be arranged along the top of the first panel member 202 and one or more pairs of attachment apertures 248 may be arranged along the bottom of the first panel member 202. Respective pairs of attachment apertures 248 may be defined at each width position of the first plurality of width positions. In such embodiments, the third panel member 206 may engage or interface with one or more pairs of attachment apertures 248 at each width position.

Each pair of attachment apertures 248 may be offset along the first panel member 202. For example, each pair of attachment apertures 248 may be offset laterally along the width of the first panel member 202. In some embodiments, each pair of attachment apertures 248 may also be offset vertically along a height of the first panel member 202. In such embodiments, each pair of attachment apertures 248 may be positioned diagonally along the first panel member 202. In some embodiments, the pair of attachment apertures 248 that are offset may impart the second vehicle partition 200 with greater rigidity when the first panel member 202 is secured to the third panel 236.

Each width position of the first plurality of width positions may correspond to a width range of the vehicle cabin 102, as described with reference to FIG. 7. For instance, a first attachment aperture or pair(s) of attachment apertures of the first set of attachment apertures 246 may correspond to a first width range of the vehicle cabin 102, a second attachment aperture or pair(s) of attachment apertures of the first set of attachment apertures 246 may correspond to a second width range of the vehicle cabin 102, and so on. Depending on the application, the difference between the maximum and minimum widths within each width range may vary or be equal across the width ranges. For example, the difference between the maximum and minimum widths of the first width range may be larger than, smaller than, or equal to the difference between the maximum and minimum widths of the second width range.

With continued reference to FIG. 8, the first panel 210 may include a plurality of slots to connect one or more attachment members to the first panel member 202. For instance, the first panel 210 may include a first pair of slots 254 to connect a first attachment member (e.g., a hook and loop fastener strap) to the first panel member 202. In some embodiments, the first panel may include a second pair of slots 256 to connect a second attachment member (e.g., a hook and loop fastener strap) to the first panel member 202. In such embodiments, the first attachment member may interface with the first pair of slots 254. Similarly, the second attachment member may interface with the second pair of slots 256. As shown, the first pair of slots 254 may be arranged vertically along the first panel 210, and the second pair of slots 256 may be arranged horizontally along the first panel 210, for purposes explained below.

Referring to FIG. 6, the second panel member 204 may include a configuration similar to the first panel member 202. For instance, the second panel member 204 may include a second set of attachment apertures 262 similar to the first set of attachment apertures 246. The second set of attachment apertures 262 may be each separated, such as incrementally along the second panel member 204, by distance D. The second set of attachment apertures 262 may impart incremental fixed changes to the width of the second vehicle partition 200, such as through selective engagement or interfacing of the third panel member 206 with at least one aperture of the second set of attachment apertures 262 along the width of the second panel member 204 to adjust a width of the second vehicle partition 200 to one of a second plurality of width positions each separated by the distance D. In some embodiments, one or more attachment apertures of the second set of attachment apertures 262 of the second panel member 204 may correspond in their location relative to one or more attachment apertures of the first set of attachment apertures 246 of the first panel member 202. For instance, should the first panel member 202 be laid over the second panel member 204, one or more attachment apertures of the first set of attachment apertures 246 of the first panel member 202 may align with one or more attachment apertures of the second set of attachment apertures 262 of the second panel member 204. In some embodiments, the second panel member 204 may include the same number of attachment apertures as the first panel member 202.

The second set of attachment apertures 262 may include one or more second pairs of attachment apertures 264 arranged along the second panel member 204 and each separated by the distance D. For example, one or more pairs of attachment apertures 264 may be arranged along the top of the second panel member 204 and one or more pairs of attachment apertures 264 may be arranged along the bottom of the second panel member 204. Respective pairs of attachment apertures 264 may be defined at each width position of the second plurality of width positions. In such embodiments, the third panel member 206 may engage or interface with one or more pairs of attachment apertures 264 at each width position.

Each width position of the second plurality of width positions may correspond to a width range of the vehicle cabin 102, as described with reference to FIG. 7. For instance, a first attachment aperture or pair(s) of apertures of the second set of attachment apertures 262 may correspond to the first width range of the vehicle cabin 102, a second aperture or pair(s) of attachment apertures of the second set of attachment apertures 262 may correspond to the second width range of the vehicle cabin 102, and so on. In some embodiments, the third panel member 206 may engage the first panel member 202 and the second panel member 204 at corresponding width positions. For example, if the width of the vehicle cabin 102 is within the first width range, the third panel member 206 may engage the aperture(s) of the first set of attachment apertures 246 and the second set of attachment apertures 262 each corresponding to the first width range.

With continued reference to FIG. 6, the plurality of interface members 220 may be configured to concurrently interface with at least one of the attachment apertures of the first set of attachment apertures 246 and at least one of the attachment apertures of the second set of attachment apertures 262 so as to adjustably define a width of the second vehicle partition 200. For example, the third panel member 206 may include a plurality of apertures 270 configured to align with at least one pair of the one or more first pairs of attachment apertures 248 of the first panel member 202 and with at least one pair of the one or more second pairs of attachment apertures 264 of the second panel member 204 to incrementally adjust the width of the second vehicle partition 200 in fixed increments.

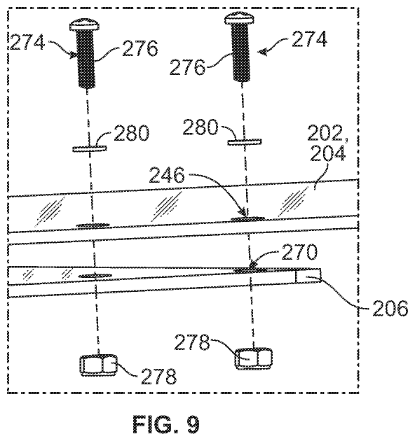

FIG. 9 illustrates an exploded view of an attachment connecting various components of the second vehicle partition 200 together in accordance with an embodiment of the disclosure. As shown, a mechanical fastener 274 may be used to connect the third panel member 206 to the first panel member 202 or the second panel member 204. For example, the mechanical fastener may include a bolt 276 extending through aligned apertures of the third panel member 206 and attachment apertures of the first panel member 202 or the second panel member 204. In such embodiments, the bolt may be secured by a nut 278. Optionally, a washer 280 may be positioned between the bolt head and the second vehicle partition 200. Although FIG. 9 illustrates use of a mechanical fastener and bolt to connect the third panel member 206 to the first panel member 202 or the second panel member 204 it should be noted that other securing means may be used including locking rails, adhesives, and the like. Although FIG. 9 illustrates that the first panel member 202 or the second panel member 204 overlays portions of the third panel member 206, it should also be noted that the first panel member 202 or the second panel member 204 may be overlaid by the portions of the third panel member 206.

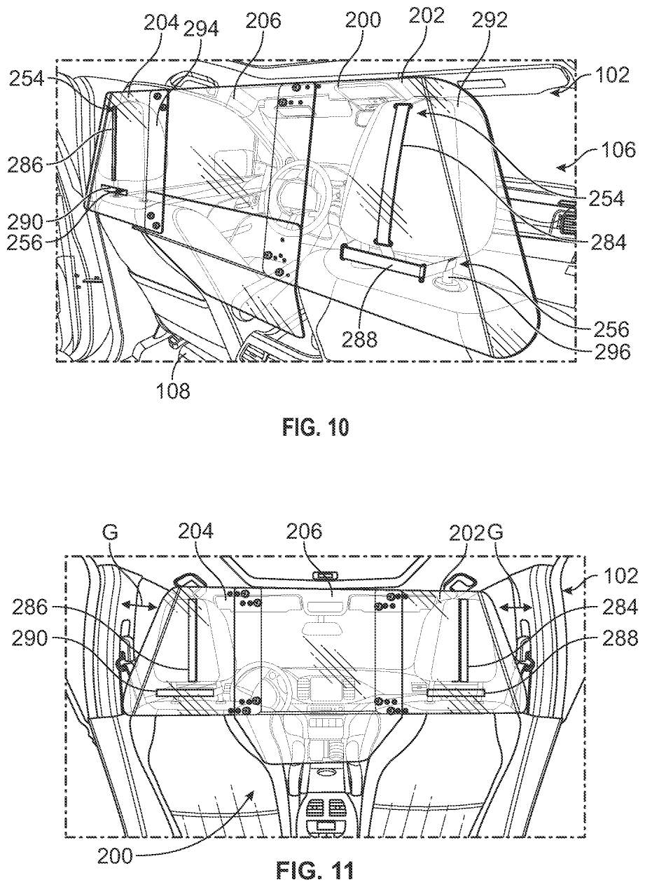

FIG. 10 illustrates a first view of the second vehicle partition 200 positioned within the vehicle cabin 102 in accordance with an embodiment of the disclosure. FIG. 11 illustrates a second view of the second vehicle partition 200 positioned within the vehicle cabin 102 in accordance with an embodiment of the disclosure. Referring to FIGS. 10-11, the second vehicle partition 200 may include a first attachment member 284 configured to attach the first panel member 202 to a first seat of the first region 106 of the vehicle cabin 102 and a second attachment member 286 configured to attach the second panel member 204 to a second seat of the first region 106 of the vehicle cabin 102. In some embodiments, the second vehicle partition 200 may include a third attachment member 288 configured to secure the first panel member 202 to the first seat and a fourth attachment member 290 configured to secure the second panel member 204 to the second seat. Each attachment member may be a strap, such as a hook-and-loop fastener strap. The first attachment member 284 may be looped through the first pair of slots 254 of the first panel 210, the second attachment member 286 may be looped through the first pair of slots 254 of the second panel 226, the third attachment member 288 may be looped through the second pair of slots 256 of the first panel 210, and the fourth attachment member 290 may be looped through the second pair of slots 256 of the second panel 226.

As shown, the first attachment member 284 and the third attachment member 288 may be configured to attach to a first headrest 292 of the first seat. In like manner, the second attachment member 286 and the fourth attachment member 290 may be configured to attach to a second headrest 294 of the second seat. For example, the first attachment member 284 may be configured to wrap vertically around the first headrest 292, and the second attachment member 286 may be configured to wrap vertically around the second headrest 294. The third attachment member 288 may be configured to attach to one or more headrest posts 296 of the first headrest 292. Similarly, the fourth attachment member 290 may be configured to attach to one or more headrest posts 296 of the second headrest 294. The first seat may be a front passenger seat, and the second seat may be a front driver seat. As one or more of the first, second, third, and fourth attachment members 284, 286, 288, and 290 are secured to the first headrest 292 and the second headrest 294, the front driver seat may be adjusted to be positioned at a substantially different position and/or reclined at a substantially different angle relative to the front passenger seat while still enabling the second vehicle partition 200 to stay secured in position to provide a barrier between the first and second regions 106, 108. Additionally, the first, second, third, and fourth attachment members 284, 286, 288, and 290 may be configured to secure to the first headrest 292 and the second headrest 294 even when the vehicle is subjected to large forces (e.g., sudden deceleration, etc.). Additionally, it should be noted that the first, second, third, and fourth attachment members 284, 286, 288, and 290 may have an adjustable amount of slack and/or tension to enable the second vehicle partition 200 to accommodate the front driver seat to be positioned at a substantially different position and/or reclined at a substantially different angle relative to the front passenger seat.

Referring to FIG. 11, the second vehicle partition 200 may be positioned such that a gap G exists on each side between the vehicle interior and the second vehicle partition 200. For example, when the second vehicle partition 200 is properly positioned and secured, the gap G may be greater than two inches. If the gap G is less than two inches, the second vehicle partition 200 may be readjusted, such as adjusting the connection between the third panel member 206 and the first panel member 202 and/or the connection between the third panel member 206 and the second panel member 204 to the next narrower aperture position. In some examples, the second vehicle partition 200 is configured to be adjusted in width to a size and shape so that the gap G is disposed between the leading edges 212, 214 and the B-pillars 120. As shown in FIG. 11, the third panel member 206 may be overlaid by portions of the front driver seat and the front passenger seat and the attachment members 284, 286, 288, and 290 may press portions of the third panel member 206 against the portions of the front driver seat and the front passenger seat so as to provide rigidity throughout portions of the third panel member 206.

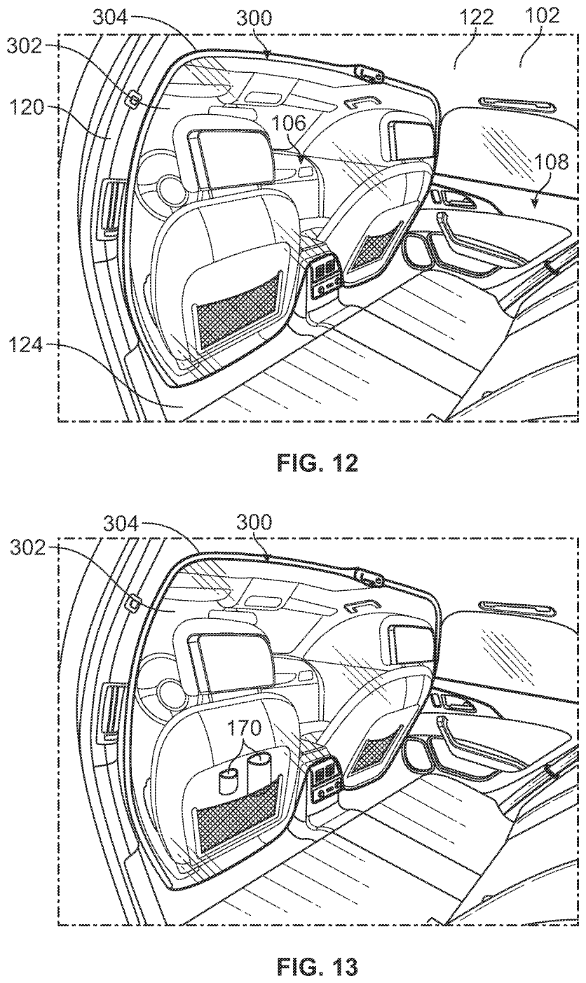

FIG. 12 illustrates a first view of a third vehicle partition 300 positioned within the vehicle cabin 102 in accordance with an embodiment of the disclosure. Except as otherwise noted below, the third vehicle partition 300 may be similar to the vehicle partition 130 of FIGS. 2-5 or the second vehicle partition 200 of FIGS. 6-11, described above, or vice versa. Accordingly, descriptions of like features may be omitted for the sake of convenience and clarity. In addition, one or more features described below with reference to the third vehicle partition 300 may be implemented on the vehicle partition 130 of FIGS. 2-5 or the second vehicle partition 200 of FIGS. 6-11. In like manner, any feature of vehicle partition 130 or second vehicle partition 200 described above may be implemented on the third vehicle partition 300, unless otherwise noted.

Referring to FIG. 12, the third vehicle partition 300 may separate the first region 106 and the second region 108, such as to eliminate or minimize potential transmission of particles, air, gas, and/or agents in the space within the vehicle cabin 102. The third vehicle partition 300 may be a quick collapsible and expandable barrier. The third vehicle partition 300 may be lightweight and quickly and easily collapsed to fold into a compact shape (e.g., for packaging, storing, or shipping in an economic manner). Like the vehicle partition 130 and the second vehicle partition 200, the third vehicle partition 300 may be configured to fit multiple vehicles and vehicle types. It should be noted that the vehicle partition 130, second vehicle partition 200, and the third vehicle partition 300 are positioned within the vehicle cabin 102 to not interfere with the functionality of the airbag system (e.g., front driver airbag, passenger airbag, side airbag, rear passenger airbag, etc.)

The third vehicle partition 300 includes a viewing window 302 and a pre-tensioned frame 304 coupled to the viewing window 302 to tension the viewing window 302. The viewing window 302 may be flexible or semi-flexible to allow the third vehicle partition 300 to be easily collapsed and folded into a compact shape. The viewing window 302 may be transparent or semi-transparent to provide a degree of optical clarity through the third vehicle partition 300. For example, the viewing window 302 may be formed from a transparent or semi-transparent film of material with sufficient strength and impermeability to provide a physical and air barrier between the first and second regions 106, 108. The transparency or semi-transparency of the viewing window 302 may enable the driver to see through the third vehicle partition 300 and into the second region 108 and/or outside vehicular traffic and environment.

The pre-tensioned frame 304 may be movable from a collapsed state to an expanded state. In some embodiments, the pre-tensioned frame 304 may be foldable between the collapsed state and the expanded state. In the collapsed state, the third vehicle partition 300 may be collapsed to fold into a compact shape. In the expanded state, the pre-tensioned frame 304 may be configured to tension the viewing window 302, such as shown in FIG. 12. The pre-tensioned frame 304 may provide sufficient tension within the viewing window 302 to provide a desired optical clarity through the viewing window 302 (e.g., limiting fold lines or creases within the viewing window 302). The pre-tensioned frame 304 may provide sufficient rigidity to the third vehicle partition 300 to provide a physical and air/gas barrier between the first and second regions 106, 108 of the vehicle cabin 102.

The pre-tensioned frame 304 may be configured to fit the third vehicle partition 300 to the vehicle cabin 102. For example, when the third vehicle partition 300 is installed within the vehicle cabin 102, the pre-tensioned frame 304 may press against at least one surface defining the vehicle cabin 102. As shown, the pre-tensioned frame 304 may press against at least one of the headliner 122, B-pillar 120, or floor 124 of the vehicle cabin 102. Similar to vehicle partition 130, the third vehicle partition 300 may provide an adaptable fit to fit a variety of different vehicles. Depending on the application, the pre-tensioned frame 304 may be configured to fit the third vehicle partition 300 around one or more features of the vehicle cabin 102. For instance, the pre-tensioned frame 304 may be shaped to fit around one or more HVAC vents, a center hump, or other interior features of the vehicle cabin 102.

Depending on the application, the third vehicle partition 300 may be secured within the vehicle cabin 102 similar to the vehicle partition 130 or the second vehicle partition 200. For example, the third vehicle partition 300 may include one or more attachment straps (not shown) for securing the third vehicle partition 300 to the front seats. In some embodiments, the third vehicle partition 300 may be secured within the vehicle interior via at least the tension (or pressing) of the pre-tensioned frame 304 against the headliner 122, B-pillars 120, and floor 124 of the vehicle cabin 102. Similar to vehicle partition, the third vehicle partition 300 may include an interface member, such as interface member 180, configured to fill or conceal any gaps between the pre-tensioned frame 304 and the vehicle cabin 102, such as using an inflatable member, foam member, drape, etc.

FIGS. 13-18 illustrate various views of the third vehicle partition 300 in accordance with an embodiment of the disclosure. Referring to FIGS. 13-18, the third vehicle partition 300 may include one or more additional features. For example, as shown in FIG. 13, the third vehicle partition 300 may include one or more pockets 170 in which to store items (e.g., hand sanitizer, etc.). As shown, the one or more pockets 170 may be coupled to the viewing window 302, such as at an area behind the driver seat and/or the front passenger seat where seat pockets are located.

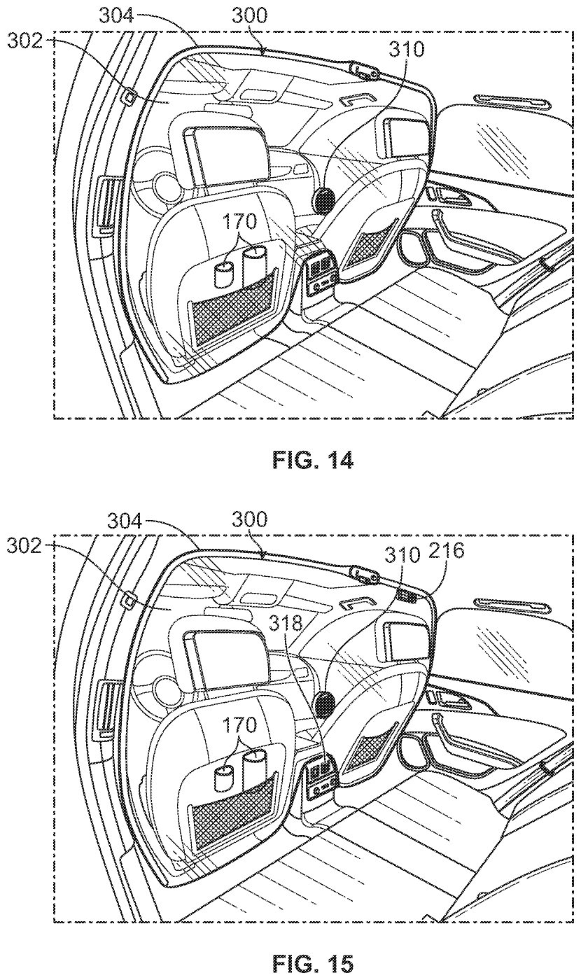

Referring to FIG. 14, the third vehicle partition 300 may include a communication device 310. For example, the third vehicle partition 300 may include a speaker and microphone setup, such as in an integrated unit, for two-way communication between a driver within the first region 106 and a passenger within the second region 108. The speaker and microphone setup may be formed, defined, or positioned within or through the viewing window 302, such as at an area between the driver seat and the front passenger seat.

Referring to FIG. 15, the third vehicle partition 300 may include one or more air filtration devices. For instance, the third vehicle partition 300 may include one or more features for one-way or two-way airflow across the third vehicle partition 300. In some embodiments, the third vehicle partition 300 may include a fan 316 for two-way airflow between the first region 106 and the second region 108. The fan 316 may include P95 filtration or the like to limit transmission of particles and agents through the air across the third vehicle partition 300. In some embodiments, the third vehicle partition 300 may include an air filter 318 positionable over the HVAC vents supplying air to the second region 108. The air filter 318 may be rated for P95 filtration.

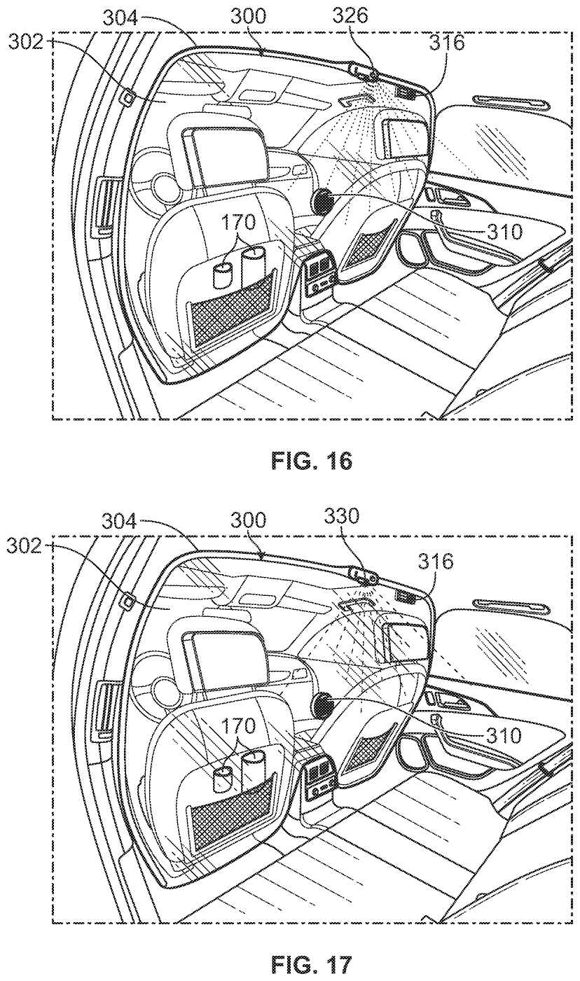

Referring to FIG. 16, the third vehicle partition 300 may include a particle removal spray system 326. The particle removal spray system 326 may be integrated with a portion of the third vehicle partition 300, such as integrated with the pre-tensioned frame 304. The particle removal spray system 326 may be activated by the driver or passenger to treat the second region 108 of the vehicle 100. In some embodiments, the particle removal spray system 326 may be activated automatically by a control system, such as automatically upon exit of the passenger at the end of every ride, automatically after a set number of rides (after 3 rides, after 5 rides, after every other ride, etc.), automatically at the end of every shift, automatically at the beginning of every shift, or the like.

Referring to FIG. 17, the third vehicle partition 300 may include a UVC emitter 330 or an ionizing photon source. Like the particle removal spray system 326, the UVC emitter 330 may be integrated with a portion of the third vehicle partition 300, such as integrated with the pre-tensioned frame 304. The UVC emitter 330 may be activated (e.g., by the driver, by the passenger, automatically by a control system, etc.) to reduce or eliminate the number of particles within the second region 108. The UVC emitter 330 may be activated similar to the particle removal spray system 326, described above. In some embodiments, the UVC emitter 330 may be a far-UVC emitter.

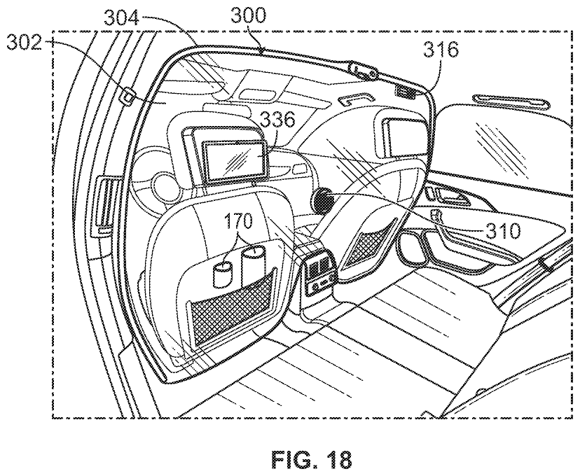

Referring to FIG. 18, the third vehicle partition 300 may include a display 336. The display 336 may be integrated with a portion of the third vehicle partition 300, such as integrated with the viewing window 302. The display 336 may be positioned within or through the viewing window 302, such as at an area behind the driver seat or behind the front passenger seat. In some embodiments, a display 336 may be positioned behind both the driver seat and the front passenger seat. The display 336 may be a touchscreen display and may render one or more advertisements and/or trip details.

In some embodiments, one or more high-touch areas of the vehicle 100 (e.g., door handles, window switches, seat belts, etc.) may include one or more covers (e.g., copper antimicrobial layer) for treating and removing particles and agents from these high-touch areas. Additionally, or alternatively, one or more high-touch areas of the vehicle 100 may be treated by the spray system 326 and/or the UVC emitter 330 (or other ionizing photon source) of the vehicle partition 130 or 300 to treat and remove particles and agents.

All relative and directional references (including upper, lower, front, rear, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

The present disclosure teaches by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A vehicle partition configured to separate a front region and a rear region of a vehicle cabin, the vehicle partition comprising:
a first panel member having a first attachment member configured to attach to a first front seat of the front region of the vehicle cabin, the first panel member comprising a first panel and a first angled edge that is angled away from the first panel;
a second panel member having a second attachment member configured to attach to a second front seat of the front region of the vehicle cabin, the second panel member comprising a second panel and a second angled edge that is angled away from the second panel; and
a third panel member connecting the first panel member to the second panel member.

2. The vehicle partition of claim 1, wherein the third panel member comprises:
a third panel connecting the first panel of the first panel member to the second panel of the second panel member; and
a third angled edge that is angled away from the third panel.

3. The vehicle partition of claim 1, wherein:
the first panel member comprises a first set of attachment apertures that are each separated by a distance and arranged along a width of the first panel member; and
the third panel member selectively interfaces with at least one aperture of the first set of attachment apertures along the width of the first panel member to adjust a width of the vehicle partition to one of a first plurality of width positions each separated by the distance.

4. The vehicle partition of claim 3, wherein:
the second panel member comprises a second set of attachment apertures that are each separated by the distance and arranged along a width of the second panel member; and
the third panel member selectively interfaces with at least one aperture of the second set of attachment apertures along the width of the second panel member to adjust a second width of the vehicle partition to one of a second plurality of width positions each separated by the distance.

5. The vehicle partition of claim 4, wherein:
the first set of attachment apertures comprises one or more first pairs of attachment apertures at each width position of the first plurality of width positions; and
the second set of attachment apertures comprises one or more second pairs of attachment apertures at each width position of the second plurality of width positions.

6. The vehicle partition of claim 5, wherein:
each of the one or more first pairs of attachment apertures comprises a pair of attachment apertures offset laterally along the width of the first panel member and offset vertically along a height of the first panel member; and
each of the one or more second pairs of attachment apertures comprises a pair of attachment apertures offset laterally along the width of the second panel member and offset vertically along a height of the second panel member.

7. The vehicle partition of claim 1, wherein:
the first panel member extends vertically from adjacent a headliner of the vehicle cabin to below a first headrest of the first front seat;
the second panel member extends vertically from adjacent the headliner to below a second headrest of the second front seat; and
the third panel member extends vertically from adjacent the headliner to adjacent a center console of the vehicle cabin.

8. The vehicle partition of claim 7, wherein:
the first panel member is secured to the first headrest via the first attachment member and a third attachment member; and
the second panel member is secured to the second headrest via the second attachment member and a fourth attachment member.

9. A vehicle partition configured to provide a barrier between a first region and a second region of a vehicle cabin, the vehicle partition comprising:
a first panel member comprising (i) a first attachment member configured to attach the first panel member to a first seat of the first region of the vehicle cabin, and (ii) a first set of attachment apertures that are separated from each other by a distance and arranged along the first panel member;
a second panel member comprising (i) a second attachment member configured to attach the second panel member to a second seat of the first region of the vehicle cabin, and (ii) a second set of attachment apertures that are separated from each other by the distance separating each of the first set of attachment apertures from each other and arranged along the second panel member; and
a third panel member connecting the first panel member to the second panel member, the third panel member comprising a plurality of interface members configured to concurrently interface with at least one of the apertures of the first set of attachment apertures and at least one of the apertures of the second set of attachment apertures so as to adjustably define a width of the vehicle partition.

10. The vehicle partition of claim 9, wherein:
the first set of attachment apertures comprises one or more first pairs of attachment apertures arranged along a first width of the first panel member and each separated by the distance;
the second set of attachment apertures comprises one or more second pairs of attachment apertures arranged along a second width of the second panel member and each separated by the distance; and
the plurality of interface members comprises a plurality of apertures configured to align with at least one pair of the one or more first pairs of attachment apertures of the first panel member and with at least one pair of the one or more second pairs of attachment apertures of the second panel member to incrementally adjust the width of the vehicle partition in fixed increments.

11. The vehicle partition of claim 10, further comprising:
one or more first mechanical fasteners received through the aligned attachment apertures of the first panel member and the apertures of the third panel member to connect the first panel member to the third panel member; and
one or more second mechanical fasteners received through the aligned attachment apertures of the second panel member and the apertures of the third panel member to connect the second panel member to the third panel member.

12. The vehicle partition of claim 9, further comprising:
a third attachment member configured to secure the first panel member to the first seat; and
a fourth attachment member configured to secure the second panel member to the second seat.

13. The vehicle partition of claim 9, wherein at least one of the first panel member, the second panel member, or the third panel member includes light-transmissive material so that the vehicle partition is configured to separate the first region from the second region of the vehicle cabin while enabling visible light to pass between the first and second regions.

14. The vehicle partition of claim 9, wherein the first panel member and the second panel member are securable to respective front seats of the vehicle cabin.

15. The vehicle partition of claim 14, wherein:
the first region is a driver seat and the second region is a passenger seat; or
the first region is a front region of the vehicle cabin and the second region is a rear region of the vehicle cabin.

16. A vehicle partition positionable between first and second regions of a vehicle cabin, the vehicle partition comprising:
a first panel member having a first attachment member configured to attach to a first front seat of the front region of the vehicle cabin, the first panel member comprising (i) a first panel and a first angled edge that is angled away from the first panel, and (ii) a first set of attachment apertures arranged along a first width of the first panel member;
a second panel member having a second attachment member configured to attach to a second front seat of the front region of the vehicle cabin, the second panel member comprising (i) a second panel and a second angled edge that is angled away from the second panel, and (ii) a second set of attachment apertures arranged along a second width of the second panel member; and
a third panel member connecting the first panel member to the second panel member, the third panel member comprising a plurality of interface members configured to concurrently interface with at least one of the apertures of the first set of attachment apertures of the first panel member and with at least one of the apertures of the second set of attachment apertures so as to adjustably define a width of the vehicle partition.

17. The vehicle partition of claim 16, wherein the third panel member comprises:
a third panel connecting the first panel of the first panel member to the second panel of the second panel member, the third panel comprising the plurality of interface members; and
a third angled edge that is angled away from the third panel.

18. The vehicle partition of claim 17, further comprising:
a third attachment member configured to attach the first panel member to the first front seat, the first attachment member and the third attachment member configured to attach to a first headrest of the first front seat; and
a fourth attachment strap configured to attach the second panel member to the second front seat, the second attachment member and the fourth attachment member configured to attach to a second headrest of the second front seat.

19. The vehicle partition of claim 18, wherein:
the first attachment member is configured to wrap vertically around the first headrest;
the second attachment member is configured to wrap vertically around the second headrest;
the third attachment member is configured to attach to one or more headrest posts of the first headrest; and
the fourth attachment member configured to attach to one or more headrest posts of the second headrest.

20. The vehicle partition of claim 17, wherein at least one of the first angled edge, the second angled edge, or the third angled edge is adjustable.
